(19) United States
(12) Patent Application Publication
(10) Pub. No.: US 2023/0144967 A1
(43) Pub. Date: May 11, 2023

(54) ACTIVE AIR PURIFICATION DEVICE

(71) Applicant: YUAN FANG APPLIED MATERIALS CO., LTD, Zhubei City (TW)

(72) Inventor: Wen-Cheng CHIEN, Hsinchu City (TW)

(73) Assignee: YUAN FANG APPLIED MATERIALS CO., LTD, Zhubei City (TW)

(21) Appl. No.: 17/541,689

(22) Filed: Dec. 3, 2021

(30) Foreign Application Priority Data
Nov. 8, 2021 (TW) 110141522

(51) Int. Cl. B01D 46/00; B01D 46/64

(52) U.S. Cl. CPC B01D 46/0027; B01D 46/64; B01D 46/0002; B01D 2259/802; B01D 2273/30; B01D 2275/202

(57) ABSTRACT

The active air purification device of the present invention includes: a first filter that is horizontally blocked on the entire flow channel and rotates, so it will actively increase the probability of air colliding with the filter. Moreover, the plural light source panels in the present invention are arranged on the flow channel to increase the range of light irradiation.

### BACKGROUND OF THE INVENTION

### 1. Field of the Invention

The present invention relates to air purification equipment, especially an active air purification device.

### 2. Description of the Related Art

At present, there are many different types of air purification equipment on the market, and one of them uses photocatalyst as a purification mechanism. Most of these products are coated with photocatalyst on a filter, and then the filter is set in the air flow channel and a light source is set to illuminate the filter. The flow of air allows the photocatalyst on the filter to contact light and air to react.

There are two most basic requirements for the use of this type of product. The first is that the air must be in contact with the filter, and the second is that the filter must be illuminated. The larger the area of the filter receiving light and the area in contact with the air, the better the efficiency of the reaction. At present, the products on the market just let the air flow through a fixed filter, that is, the filter is passively waiting for the air to collide, and the light source is mostly set on the periphery of the filter, which is also fixed relative to the filter, so most of the light can only shine on the outer surface of the filter, so the area that can be reacted will be limited. Especially when the area of the filter is large, the light source arranged on the periphery of the filter is difficult to provide light to the inner middle area of the filter.

### SUMMARY OF THE INVENTION

The present invention has been accomplished under the circumstance in view. It is therefore the main object of the present invention to provide an active air purification device, which increases the area of the filter irradiated by light and increases the chance of collision between the filter and the air.

To achieve the aforesaid object, the active air purification device of the present invention comprises: a shell defining an accommodating space and an opening; a motor set in the shell and comprising a shaft; a fan blade set located in the accommodating space of the shell and connected to the shaft of the motor and drivable by the motor to rotate; a first filter rotatable along an axis and set on one side of the fan blade set and equipped with a photocatalyst; and a light source module comprising a base, a lower ring, an upper ring and a plurality of light source panels. The lower ring is set on the base and rotatable relative to the base. Each light source panel comprises an arc-shaped arm portion, and a light-emitting portion provided on one side of the arc-shaped arm portion. One end of the arc-shaped arm portion of each light source panel is pivoted to the lower ring, and each light source panel rotates relative to the lower ring with the pivot position as the axis, so that the light source panels move from an original close to each other state to a far apart state.

Preferably, the light source module is set at the opening of the shell when it is set.

Preferably, a filter is provided on each of both sides of the light source module.

It can be seen from the above structure that the first filter of the active air purification device of the present invention will be horizontally blocked on the entire flow channel and rotate, forcing air to pass through the first filter before it can enter the shell. Therefore, in addition to the collision of air with the first filter when it is flowing, the rotation of the first filter will also actively increase the probability of air colliding with the filter, and because these light source panels are correspondingly arranged on the mesh surface of the filter, rather than arranged on the periphery of the filter, the range of light irradiation can be increased to achieve the purpose of the present invention.

The detailed structure, characteristics, assembly or use mode provided by the present invention will be described in the detailed description of the subsequent implementation mode. However, those with ordinary knowledge in the field of the present invention should be able to understand that these detailed descriptions and the specific embodiments listed in the implementation of the present invention are only used to illustrate the present invention, and are not intended to limit the scope of the patent application of the present invention.

### BRIEF DESCRIPTION OF THE DRAWINGS

FIG. 1 is a schematic elevational of the present invention.

FIG. 2 is an exploded schematic diagram of the first embodiment of the present invention.

FIG. 3 is an exploded schematic diagram of the light source module of the present invention.

FIG. 4 is a front view of the first embodiment of the present invention.

FIG. 5 is a front view of the first embodiment of the present invention after removing the second filter and the upper ring.

FIG. 6 is the same as FIG. 5, and is a schematic diagram of the light source panels of the present invention after being expanded.

FIG. 7 is a cross-sectional view in the direction of section line 7-7 in FIG. 1.

FIG. 8 is an exploded schematic diagram of the second embodiment of the present invention.

FIG. 9 is the same as FIG. 7, which is a cross-sectional view of the second embodiment of the present invention.

FIG. 10 is a cross-sectional view of the third embodiment of the present invention.

FIG. 11 is an exploded schematic diagram of the fourth embodiment of the present invention.

FIG. 12 is a cross-sectional view of the fourth embodiment of the present invention.

### DETAILED DESCRIPTION OF THE INVENTION

The applicant first explains here that in this specification, including the embodiments described below and the claims of the scope of patent application, the nouns related to directionality are based on the direction in the diagram. Secondly, in the embodiments and drawings that will be introduced below, the same element numbers represent the same or similar elements or their structural features.

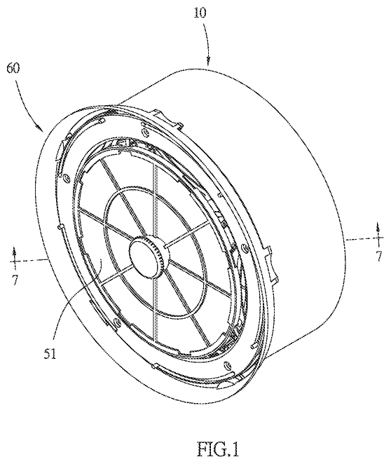

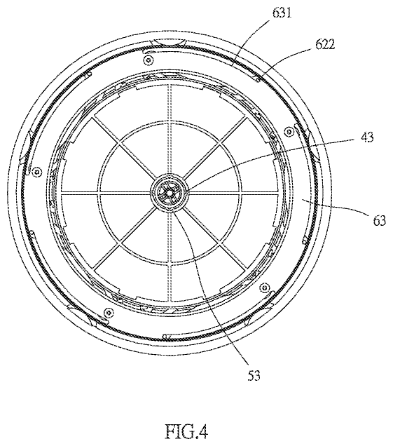

Please refer to FIGS. 1 to 7, which are the first embodiment of the present invention. The active air purification device of the present invention comprises a shell 10, a motor 20, a fan blade set 30, a first filter 50, a second filter 51, and a light source module 60.

The shell 10 defines an accommodating space 11 and an opening 12.

The motor 20 has a shaft 21, and is located in the accommodating space 11 of the shell 10.

The fan blade set 30 is set in the accommodating space 11 of the shell 10 and connected to the shaft 21 of the motor, and can be driven by the motor 20 to rotate.

The first filter 50 and the second filter 51 are set on the same side of the fan blade set 30. The second filter 51 is coated with a photocatalyst. The first filter 50 and the second filter 51 can rotate along an axis. In this embodiment, the first filter 50 and the second filter 51 are arranged on the motor shaft 21 and can rotate with the shaft 21. The first filter 50 and the second filter 51 each have a perforation 52 in the center. The shaft 21 is provided with a center column 22, so that the shaft 21 can extend through the perforation 52 of the first filter 50 and the perforation 52 of the second filter 51 and the shaft 21 can drive the first filter 50 and the second filter 51 to rotate, but it is not limited to this.

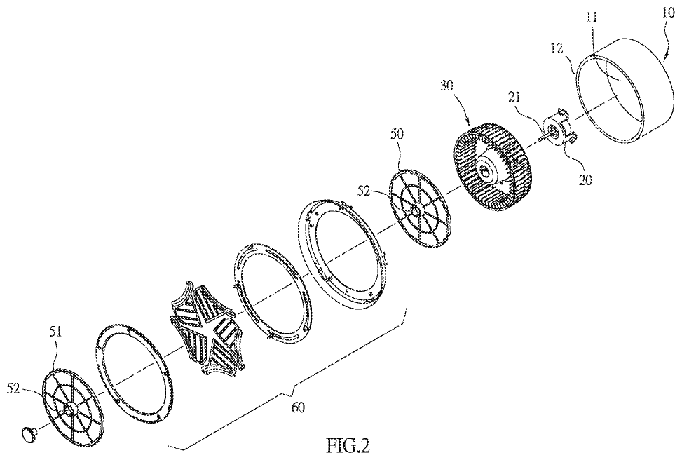

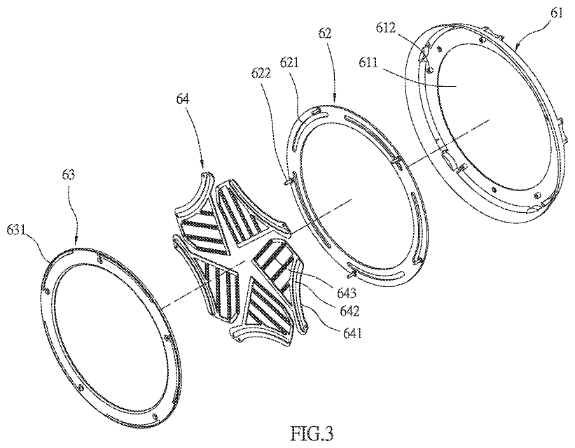

The light source module 60, as shown in FIGS. 2 and 3, comprises: a base 61, a lower ring 62, an upper ring 63, and a plurality of light source panels 64.

The base 61 is ring-shaped with a hollow area 611 in the middle, and the base is provided with a plurality of convex posts 612 on one side of the ring.

The lower ring 62 is set on the base 61 and can rotate relative to the base 61. The lower ring 62 is provided with a plurality of arc-shaped long holes 621, and the plurality of convex posts 612 of the base are respectively penetrated in arc-shaped long holes 621. The lower ring 62 is also provided with a pivot post 622 on one side of each arc-shaped long hole 621.

Since the plural light source panels 64 have the same structure, the structure of one of the light source panels is used as an illustration here. The light source panel has an arc-shaped arm portion 641, the arm portion 641 is provided with an arc-shaped long guide slot 642, one side of the arm portion 641 is provided with a light-emitting portion 643, the light-emitting portion is provided with a plurality of LEDs. The light source panel 64 is pivoted to the pivot post 622 of the lower ring with one end of the arm portion 641. The light source panel can rotate with the pivot post 622 as the axis relative to the lower ring 62. The convex post 612 of the base passes through the arc-shaped long hole 621 of the lower ring and then passes through the long guide slot 642.

The upper ring 63 is covered on the lower ring 62, and is bolted to the convex post 612 of the base, so that the light source panels 64 are located between the upper ring 63 and the lower ring 62. The upper ring 63 is provided with a plurality of arc-shaped grooves 631, and the pivot posts 622 of the lower ring 62 are respectively passed through the arc-shaped grooves 631.

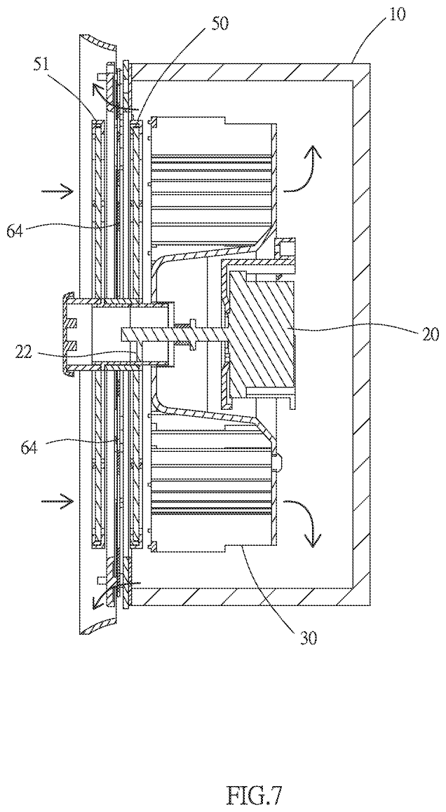

The light source module 60 is set at the opening 12 of the shell when it is set up, and the light source panels 64 are located between the first filter 50 and the second filter 51, and the center of the lower ring 62 is on the same axis as the two perforations 52, as shown in FIGS. 2 and 7.

The structure of the present invention is described above. The difference between the present invention and existing products is: When in use, the motor 20 will drive the fan blade set 30 to rotate and drive the air flow through the first filter 50 to the light source panels 64, then pass the second filter 51 into the shell 10, and then flow out from the edge of the shell 10. Moreover, the first filter 50 and the second filter 51 will be horizontally blocked on the entire flow channel and rotate with the rotation of the fan blade set 30, forcing air to pass through the first filter 50 and the second filter 51 before it can enter the shell. Therefore, in addition to the collision of air with the first filter 50 and the second filter 51 when the air is flowing, the rotation of the first filter 50 and the second filter 51 will also actively increase the probability of the air colliding with the filters. And because the light source panels 64 are arranged between the first filter 50 and the second filter 51, light can be irradiated to the first filter 50 and the second filter 51 at the same time to increase the range of light irradiation.

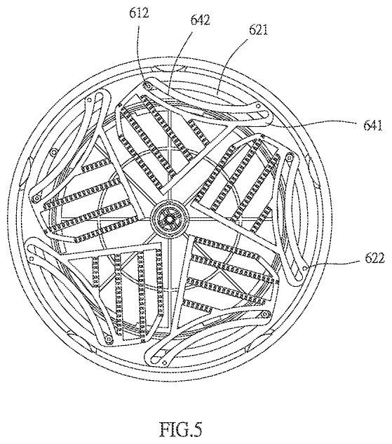

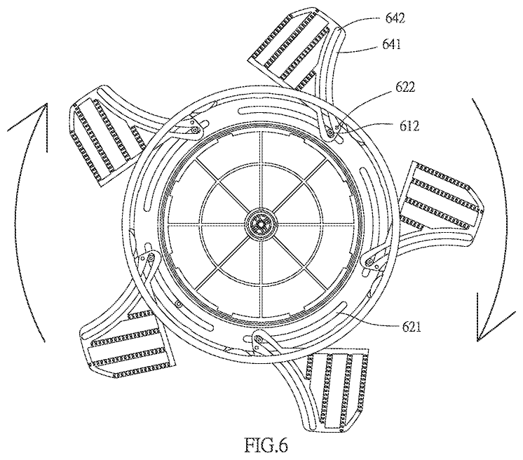

When the first filter 50 and the second filter 51 need to be removed for cleaning or replacement, the user can turn the lower ring 62. Due to the rotation of the lower ring 62, the convex posts 612 of the base 61 will move along the respective arc-shaped long holes 621 of the lower ring 62 and the long guide slots 642 of the respective light source panels 64, so that the light source panels 64 are forced to rotate around the pivot posts 622 pivoted by the arm portions 641, so that the light source panels 64 are expanded outward, as shown in FIG. 6. In this way, the light source panels 64 can be moved away from the original position between the first filter 50 and the second filter 51, from the original close to each other state as shown in FIG. 5 to the state far away from each other as shown in FIG. 6, and the first filter 50 and the second filter 51 can then be removed for cleaning or replacement.

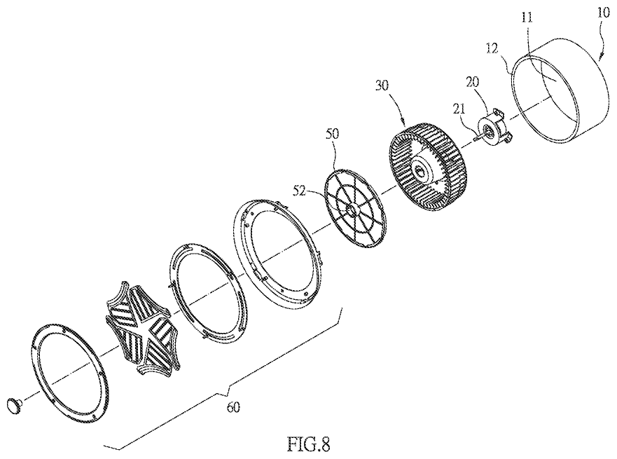

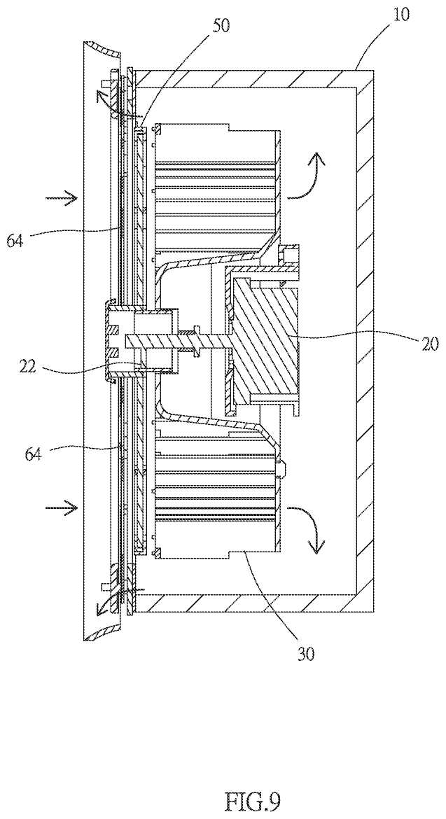

FIGS. 8 and 9 show the second embodiment of the present invention. The structure in this second embodiment is almost the same as the previous first embodiment. The difference is that in this second embodiment, only the first filter 50 is set and the second filter 51 is not set.

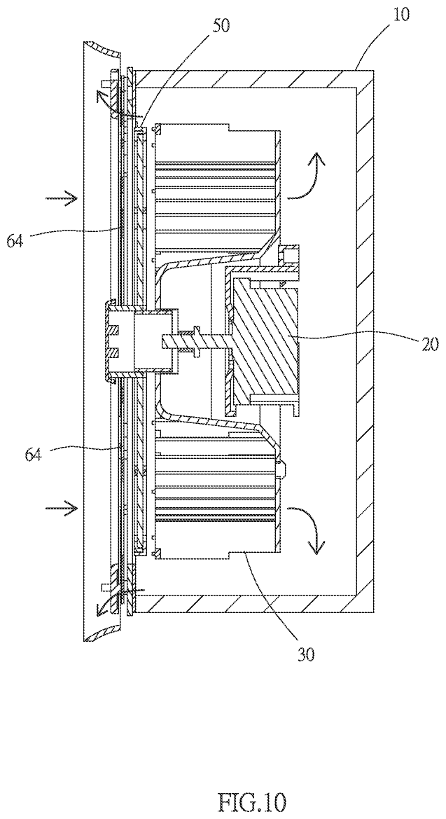

FIG. 10 shows the third embodiment of the present invention. In this third embodiment, the structure is similar to the second embodiment, but the first filter 50 is not connected to the shaft 21, but is only set on one side of the fan blade set 30. In this third embodiment, the first filter 50 is not driven by the shaft 21 to rotate but is driven by the air flow when the air flows. The airflow is used to drive the first filter 50 to rotate along a virtual axis. The first filter 50 can be set between the light source module 60 and the fan blade set 30, or the light source module 60 can be set between the first filter 50 and the fan blade set 30.

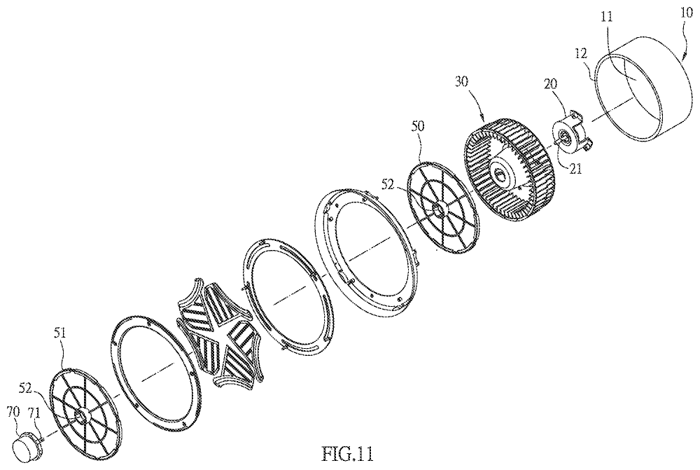

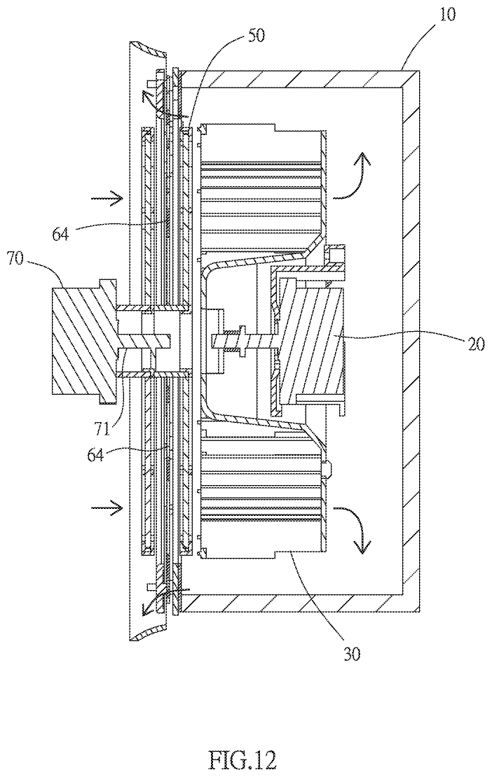

FIGS. 11 and 12 show the fourth embodiment of the present invention. The structure of this fourth embodiment is similar to that of the first embodiment. In addition to the structure of the first embodiment, a second motor 70 is further provided in this fourth embodiment. The second motor 70 has a shaft 71. In this fourth embodiment, the first filter 50 and the second filter 51 are not connected to the original motor shaft 21, but are connected to the shaft 71 of the second motor 70, so that the first filter 50 and the second filter 51 can be driven to rotate by the second motor 70. In this way, the rotation speed of the first filter 50 and the second filter 51 can be further controlled, so that their rotation is synchronized or not synchronized with the fan blade set 30, thereby creating a better chance for the filters to actively collide with the air.

What is claimed is:

1. An active air purification device, comprising:
a shell defining an accommodating space and an opening;
a motor comprising a shaft, said motor being set in said shell;
a fan blade set located in said accommodating space of said shell and connected to said shaft of said motor and drivable by said motor to rotate;
a first filter rotatable along an axis, said first filter being set on one side of said fan blade set and equipped with a photocatalyst; and
a light source module set at said opening of said shell on one side of said first filter and adapted for illuminating said first filter, said light source module comprising a base, a lower ring, an upper ring and a plurality of light source panels, the center of said lower ring being the same axis as the rotation axis of said first filter.

2. The active air purification device as claimed in claim 1, wherein said first filter is connected to and rotatable with said shaft of said motor.

3. The active air purification device as claimed in claim 2, further comprising a second filter set on said shaft of said motor and rotatable with said shaft of said motor, wherein said light source module is set between said first filter and said second filter.

4. The active air purification device as claimed in claim 3, wherein said lower ring is set on said base and rotatable relative to said base; each said light source panel comprises an arc-shaped arm portion and a light-emitting portion provided on one side of said arc-shaped arm portion; each said light source panel is pivoted to said lower ring with one end of the said arc-shaped arm portion thereof and rotates relative to said lower ring with the pivot position as the axis, so that said light source panels move from an original close to each other state to a far apart state.

5. The active air purification device as claimed in claim 4, wherein said base is ring-shaped with a hollow area in the middle, and comprises a plurality of convex posts on one side thereof; said lower ring comprises a plurality of arc-shaped long holes respectively coupled to said convex posts of said base, and a plurality of pivot posts respectively disposed at one side relative to the respective said arc-shaped long holes; said arm portions of said light source panels have respective one ends thereof respectively pivoted to said pivot posts of said lower ring.

6. The active air purification device as claimed in claim 5, wherein said arc-shaped arm portion of each said light source panel is provided with an arc-shaped long guide slot; said convex posts of said base respectively pass through said arc-shaped long holes of said lower ring and are then respectively inserted into said long guide slots of said light source panels.

7. The active air purification device as claimed in claim 1, wherein said first filter is driven by the airflow when the air flows, and the airflow is used to drive said first filter to rotate along a virtual axis.

8. The active air purification device as claimed in claim 7, further comprising a second filter set on one side of said light source module and rotatable along said virtual axis; said light source module is set between said first filter and said second filter.

9. The active air purification device as claimed in claim 8, wherein said lower ring is set on said base and rotatable relative to said base; each said light source panel comprises an arc-shaped arm portion and a light-emitting portion provided on one side of said arc-shaped arm portion; each said light source panel is pivoted to said lower ring with one end of the said arc-shaped arm portion thereof and rotates relative to said lower ring with the pivot position as the axis, so that said light source panels move from an original close to each other state to a far apart state.

10. The active air purification device as claimed in claim 9, wherein said base is ring-shaped with a hollow area in the middle, and comprises a plurality of convex posts on one side thereof; said lower ring comprises a plurality of arc-shaped long holes respectively coupled to said convex posts of said base, and a plurality of pivot posts respectively disposed at one side relative to the respective said arc-shaped long holes; said arm portions of said light source panels have respective one ends thereof respectively pivoted to said pivot posts of said lower ring.

11. The active air purification device as claimed in claim 10, wherein said arc-shaped arm portion of each said light source panel is provided with an arc-shaped long guide slot; said convex posts of said base respectively pass through said arc-shaped long holes of said lower ring and are then respectively inserted into said long guide slots of said light source panels.

12. The active air purification device as claimed in claim 1, further comprising a second motor, said second motor comprising a shaft connected with said first filter so that said first filter is rotatable with said shaft of said second motor.

13. The active air purification device as claimed in claim 12, further comprising a second filter set on said shaft of said second motor and rotatable with said shaft of said second motor, wherein said light source module is set between said first filter and said second filter.

14. The active air purification device as claimed in claim 13, wherein said lower ring is set on said base and rotatable relative to said base; each said light source panel comprises an arc-shaped arm portion and a light-emitting portion provided on one side of said arc-shaped arm portion; each said light source panel is pivoted to said lower ring with one end of the said arc-shaped arm portion thereof and rotates relative to said lower ring with the pivot position as the axis, so that said light source panels move from an original close to each other state to a far apart state.

15. The active air purification device as claimed in claim 14, wherein said base is ring-shaped with a hollow area in the middle, and comprises a plurality of convex posts on one side thereof; said lower ring comprises a plurality of arc-shaped long holes respectively coupled to said convex posts of said base, and a plurality of pivot posts respectively disposed at one side relative to the respective said arc-shaped long holes; said arm portions of said light source panels have respective one ends thereof respectively pivoted to said pivot posts of said lower ring.

16. The active air purification device as claimed in claim 15, wherein said arc-shaped arm portion of each said light source panel is provided with an arc-shaped long guide slot; said convex posts of said base respectively pass through said arc-shaped long holes of said lower ring and are then respectively inserted into said long guide slots of said light source panels.
